(19) United States
(12) Patent Application Publication
(10) Pub. No.: US 2004/0228318 A1
(43) Pub. Date: Nov. 18, 2004

(54) Method of optimizing the performance of a mobile radio system

(75) Inventor: Stanislas Bourdeaut, Paris (FR)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 10/765,133

(22) Filed: Jan. 28, 2004

(30) Foreign Application Priority Data
Jan. 29, 2003 (FR) 03 01 017

(51) Int. Cl. H04L 12/66; H04L 12/28; H04L 12/56

(52) U.S. Cl. 370/349; 370/352; 370/401

(57) ABSTRACT

A method of optimizing the performance of a mobile radio system in which different transfer modes correspond to different bit rates corresponding to different modulation schemes and the protocol architecture uses a radio link control layer that can operate in an acknowledged mode or in a non-acknowledged mode, in which method, in a transfer mode corresponding to the highest bit rates, acknowledgment information is sent in the non-acknowledged mode from a radio link control receiver to a radio link control sender and can be taken into account by the radio link control sender.

The present invention relates generally to mobile radio systems.

Various processing operations are necessary in mobile radio systems to convert information for sending over the radio interface into a format suitable for being sent.

For example, protection against transmission errors is obtained by coding, such as error correction coding in particular, which coding serves to introduce redundancy into the information that is sent. A coding rate is defined as the ratio of the number of information bits to be sent to the number of bits sent or the number of coded bits. Coding is generally applied to blocks or sequences of information bits. For given allocated radio resources, the higher the coding rate, the higher the information bit rate. However, a high coding rate necessitates good radio conditions, in the absence of which the quality of service is degraded.

Additional protection against transmission errors is generally provided for data services, generally by sending again blocks that are not received correctly, using an Automatic Repeat reQuest (ARQ) technique. Blocks that are not received correctly include blocks in which errors are detected (by an error detection code) and blocks in which errors cannot be corrected (by an error correction code). The receiver informs the sender of the correct or incorrect state of the blocks it has received by means of acknowledgment/non-acknowledgment (ACK/NACK) messages. This mode of operation is referred to as an “acknowledged mode”. An “unacknowledged mode” can also be used, in particular for applications such as real-time applications, for example, in which the time delays introduced by such resending and acknowledgment mechanisms would be unacceptable. Moreover, for improved efficiency, acknowledgments/non-acknowledgments are generally grouped together in a single ACK/NACK message for a set of successive blocks. An ACK/NACK message then comprises a bitmap in which each bit is used for the acknowledgment/non-acknowledgment of one of the blocks. For example, a 0 bit can indicate that a block has not been received correctly, and conversely a 1 bit can indicate that a block has been received correctly.

Another processing operation is modulation, producing an analogue signal bearing information to be transmitted. The person skilled in the art knows various modulation techniques, which are characterized by their spectral efficiency, i.e. their capacity to transmit a greater or lesser number of bits per symbol using the same allocated frequency band. For example, the General Packet Radio Service (GPRS) system uses only one modulation technique, by gaussian minimum shift keying (GMSK) modulation, sending one bit per symbol, whereas the Enhanced General Packet Radio Service (EGPRS) system uses two modulation techniques, GMSK modulation, sending one bit per symbol, and modulation by eight-value phase shift keying (8PSK), sending three bits per symbol. The higher the spectral efficiency of the modulation, the higher the transmitted bit rate can be. However, high spectral efficiency necessitates good radio conditions, in the absence of which the quality of service is degraded.

Various techniques can be used to optimize the performance of such systems, such as the link adaptation technique in particular, which dynamically adapts the coding scheme and/or the modulation scheme as a function of radio conditions. In particular, if radio conditions are good, the coding rate can be increased and/or a modulation technique of higher spectral efficiency can be used, to increase the bit rate. For example, there are four coding schemes CS1 to CS4 in the GPRS system and nine modulation and coding schemes MCS1 to MCS9 in the EGPRS system.

The quality of a radio link is generally represented by one or more quality indicators, such as in particular the raw bit error rate (BER), the block erasure rate (BLER), the signal-to-interference ratio (SIR), etc. The BLER corresponds to the proportion of data blocks not received correctly. If the resending technique is used, the BLER, unlike other quality indicators, can also be determined by the sender, from ACK/NACK messages sent by the receiver. Because algorithms such as link adaptation algorithms, for example, or cell re-selection algorithms, are generally implemented within the network, the network can itself determine the BLER, for the downlink direction, without it being necessary for the mobile station to report back to the network the BLER value that it determines.

As a general rule, mobile radio systems are the subject of standardization, and for a complete description of such systems the corresponding standards published by the corresponding standards bodies can be consulted.

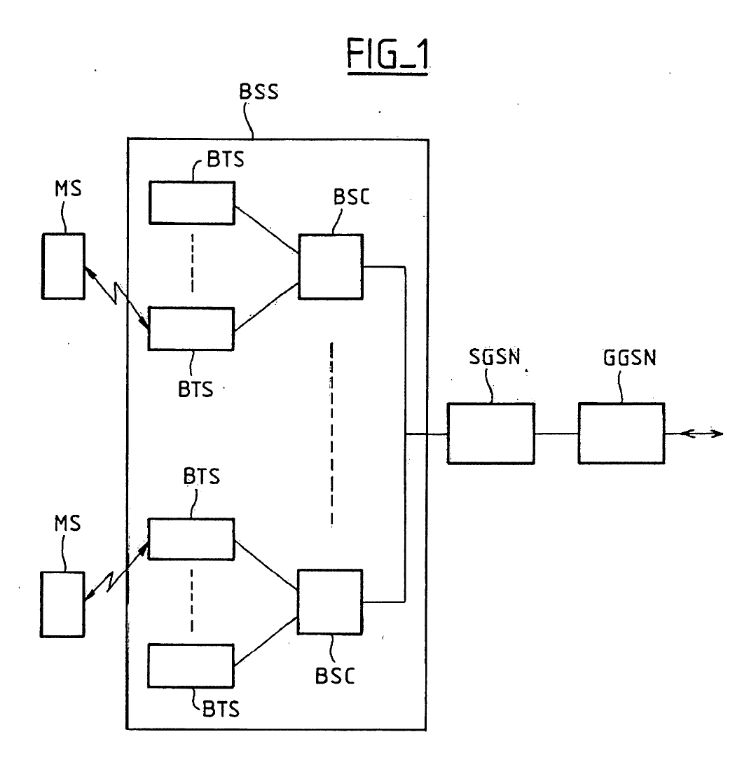

FIG. 1 outlines the general architecture of GPRS systems, essentially comprising:

a base station sub-system BSS communicating with mobile stations MS and comprising base transceiver stations BTS and base station controllers BSC, and

a GPRS network sub-system communicating with the BSS and with external networks (not shown), and comprising GPRS network sub-system nodes or entities, such as Serving GPRS Support Node and Gateway GPRS Support Node entities SGSN and GGSN, respectively.

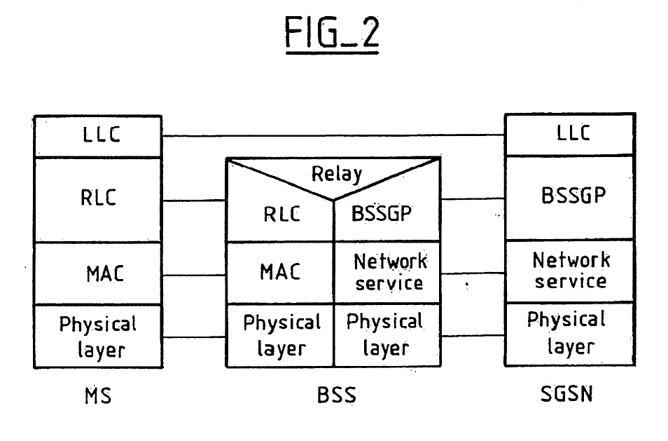

In the layered architecture used to define these systems, and as shown in FIG. 2, at the MS/BSS interface, or the radio interface or “Um” interface as it is otherwise known, a distinction is drawn between:

a first layer, or physical layer as it is otherwise known, and

a second layer, or link layer as it is otherwise known, which is itself divided into a plurality of layers, namely, in order of increasing level: Medium Access Control (MAC), Radio Link Control (RLC), and Logical Link Control (LLC), the BSS being used only as a relay between the MS and the GPRS network sub-system, for the LLC layer.

Similarly, at the interface between the BSS and the GPRS network sub-system, or the “Gb” interface as it is otherwise known, a distinction is drawn between:

a first layer, or physical layer as it is otherwise known, and

a second layer, or link layer as it is otherwise known, which is itself divided into a plurality of layers, namely, in order of increasing level: network service, BSS GPRS Protocol (BSSGP), and Logical Link Control (LLC), the BSS being used only as a relay between the MS and the GPRS network sub-system, for the LLC layer.

Moreover, higher level signaling protocols (not specifically shown in the figure) are also provided, in particular for mobility management (MM) protocols, session management (SM) protocols, etc.

LLC frames are formed in the LLC layer from higher level data units. In LLC frames, those data units are referred to as LLC-protocol data units (LLC-PDU).

The LLC-PDU are then segmented in the RLC-MAC layer to form RLC data blocks. The RLC data blocks are then converted in the physical layer to the format required for sending at the “Um” interface.

Procedures for re-sending data that has not been received correctly are generally implemented in the RLC and LLC layers, in respect of RLC data blocks and LLC-PDU, as appropriate, using the Automatic Repeat reQuest (ARQ) technique referred to above.

Hereinafter, and by way of example, the emphasis is on the RLC layer in the GPRS system. In respect of this example, see the 3GPP Technical Specification TS 44.060. In particular, according to that specification, an ACK/NACK message contains a Starting Sequence Number (SSN) and a Received Block Bitmap (RBB).

As mentioned above, the standards for the GPRS have evolved, in particular with the introduction of the Enhanced General Packet Radio Service (EGPRS), which offers bit rates that are much higher than those offered by the GPRS. However, within the same system, not all mobile stations and not all pieces of network equipment necessarily support the EGPRS. There are therefore two Temporary Block Flow (TBF) modes, namely a GPRS mode and an EGPRS mode.

The current version of the relevant 3GPP Technical Specification (3GPP TS 44.060 V6.0.0 (2002-12)) states that:

for a GPRS mode TBF, the SSN and the RBB are sent in the unacknowledged RLC mode and in the acknowledged RLC mode, and the SSN and the RBB can be ignored by the unacknowledged RLC mode sender,

for an EGPRS mode TBF, the SSN and the RBB are sent in the unacknowledged RLC mode and in the acknowledged RLC mode, and the SSN and the RBB must be ignored by the unacknowledged RLC mode receiver.

The Applicant has noted that problems arise from the current version of the above specification.

First of all, it is assumed that, within the above-mentioned terms of that specification, in the case of EGPRS mode, the term “RLC mode receiver” should be replaced by “RLC mode sender”. However, the Applicant has realized that a problem arises even with such a replacement, because, according to the current specification, there is nothing to oblige an RLC receiver (in particular, in the case of the downlink direction, a mobile station) to send valid SSN and RBB information, since that information is ignored by the RLC sender (in particular, in the downlink direction, a piece of network equipment). Now, there is every benefit in the SSN and RBB information being valid and being taken into account by the RLC receiver. For example, this information could be used to estimate transmission quality, especially if a link adaptation technique is used, as mentioned above.

A particular object of the present invention is to solve some or all of the above problems and/or to avoid some or all of the above drawbacks. More generally, an object of the present invention is to optimize the performance of the above systems.

The present invention consists in a method of optimizing the performance of a mobile radio system in which different transfer modes correspond to different bit rates corresponding to different modulation schemes and the protocol architecture uses a radio link control layer that can operate in an acknowledged mode or in a non-acknowledged mode, in which method, in a transfer mode corresponding to the highest bit rates, acknowledgment information is sent in the non-acknowledged mode from a radio link control receiver to a radio link control sender and can be taken into account by the radio link control sender.

According to another feature, the transfer modes include a General Packet Radio Service (GPRS) mode and an Enhanced General Packet Radio Service (EGPRS) mode.

According to another feature, said acknowledgment information comprises a Starting Sequence Number (SSN) and a Received Block Bitmap (RBB) transmitted in an Acknowledgment/Non-Acknowledgment (ACK/NACK) message.

According to another feature, said acknowledgment information is taken into account by an RLC sender to estimate transmission quality.

According to another feature, said transmission quality estimate is used for the purposes of radio link adaptation.

The invention also consists in a mobile station including means for implementing a method of the invention.

The invention further consists in a mobile radio network equipment including means for implementing a method of the invention.

The invention further consists in a mobile radio system including means for implementing a method of the invention.

Other objects and features of the present invention will become apparent on reading the following description of one embodiment of the invention, given with reference to the appended drawings, in which:

FIG. 1 outlines the general architecture of a packet mode mobile radio system,

FIG. 2 outlines the protocol architecture used in a system of the type shown in FIG. 1, and

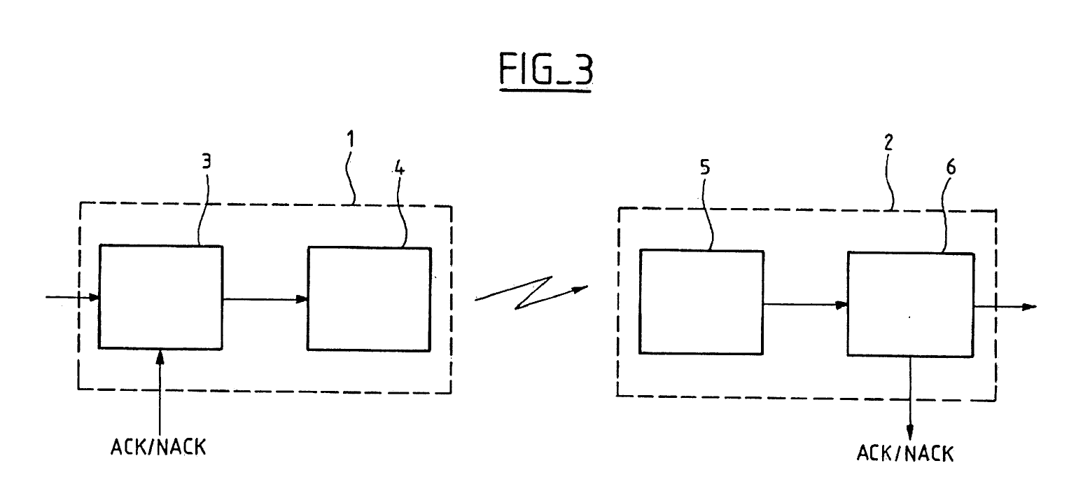

FIG. 3 is a diagram used to illustrate an example of the use of a method of the invention.

FIG. 3 shows diagrammatically and by way of example a radio link between an RLC sender and an RLC receiver in a mobile radio system. For example, the RLC sender 1 can be in a mobile station and the RLC receiver 2 can be in the network. The link is then an uplink. Conversely, the sender 1 can be in the network and the receiver 2 can be in a mobile station. The link is then a downlink.

In the example shown, the sender 1 comprises:

send processing means 3, including functions such as coding, modulation, etc., and

radio frequency sending means 4.

In the example shown, the receiver 2 includes:

radio frequency receiving means 5, and

receive processing means 6, including in particular functions such as decoding, demodulation, etc.

In the acknowledged mode and in the non-acknowledged mode, the processing means 6 generate an ACK/NACK message including acknowledgment information such as the above-mentioned SSN and RBB, for example, and send said messages to the sender 1.

In the acknowledged mode, the processing means 3 send again blocks that have not been received correctly, under the control of ACK/NACK messages received from the receiver 2.

In the current version of the above-referenced specification, in the non-acknowledged mode, the processing means 3 of the sender 1 can ignore acknowledgment information such as the SSN and the RBB in particular in the case of a GPRS mode TBF, which the processing means 3 of the sender 1 must ignore in the case of an EGPRS mode TBF.

The present invention proposes that the acknowledgment information, such as the SSN and the RBB in particular, be taken into account in the non-acknowledged mode, in the case of a GPRS mode TBF. This optimizes the performance of the system; in particular, as mentioned above, this information can be taken into account to estimate transmission quality, especially if a link adaptation algorithm is used.

The present invention also consists in a mobile station, a mobile radio network equipment, and a mobile radio system all including means for implementing a method of the invention.

Since the particular implementation of such means do not represent any particular problem for the person skilled in the art, such means need not be described here in greater detail than by describing their function, as described above.

1. A method of optimizing the performance of a mobile radio system in which different transfer modes correspond to different bit rates corresponding to different modulation schemes and the protocol architecture uses a radio link control layer that can operate in an acknowledged mode or in a non-acknowledged mode, in which method, in a transfer mode corresponding to the highest bit rates, acknowledgment information is sent in the non-acknowledged mode from a radio link control receiver to a radio link control sender and can be taken into account by the radio link control sender.

2. A method according to claim 1, wherein said transfer modes include the General Packet Radio Service (GPRS) mode and the Enhanced General Packet Radio Service (EGPRS) mode.

3. A method according to either claim 1, wherein said acknowledgment information includes a Starting Sequence Number (SSN) and a Received Block Bitmap (RBB) sent in an acknowledgment/non-acknowledgment (ACK/NACK) message.

4. A method according to claim 1, wherein said acknowledgment information is taken into account by an RLC sender to estimate transmission quality.

5. A method according to claim 4, wherein said transmission quality estimate is used for radio link adaptation.

6. A mobile station including means for implementing a method according to claim 1.

7. Mobile radio network equipment, including means for implementing a method according to claim 1.

8. A mobile radio system including means for implementing a method according to claim 1.
